(19) United States
(12) Patent Application Publication
(10) Pub. No.: US 2005/0040939 A1
(43) Pub. Date: Feb. 24, 2005

(54) Integrated motorcoach management system apparatus and method

(76) Inventors: Janard J. Jobes I, Eagle, ID (US); Les Neva, Eagle, ID (US); John Prestwich, Boise, ID (US); Jeff Aguilera, Nampa, ID (US); Jason Main, Garden City, ID (US); Darrell Werries, Meridian, ID (US)

Correspondence Address: A John Pate;Pate Pierce and Bard, Parkside Tower, 215 South State Street Suite 550, Salt Lake City, UT, 84111, US

(21) Appl. No.: 10/645,285

(22) Filed: Aug. 21, 2003

(51) Int. Cl. B60Q 1/00

(52) U.S. Cl. 340/438

(57) ABSTRACT

An apparatus in accordance with the invention is provided for managing various components of a motorcoach (e.g motorhome, recreational, and commercial vehicle) through a rear-view display monitor. For example, such a system may include a rear-view camera that provides a video signal comprising captured images of subject matter to the rear of a motorcoach. The video signal may be transmitted and displayed on a monitor. A coach management module in accordance with the invention may be integrated with the camera and monitor to display, simultaneously, coach data or information in the form of text and symbols, with the video signal from the rear-view camera, on the monitor.

### BACKGROUND

1. The Field of the Invention

This invention relates to recreational vehicles and more particularly to apparatus and methods for integrating vehicle and coach management systems in recreational or commercial vehicles.

2. The Background Art

Motorcoaches (or motorhomes, recreational vehicles, and the like, as they are commonly referred to) can be awkward to operate for drivers or operators who may not be accustomed to or trained to operate such large vehicles. Compared to traditional automobiles, motorcoaches have vastly reduced maneuverability and visibility. Moreover, the trend for bigger and more elaborately equipped motorcoaches appears to be on the increase. In fact, it is not uncommon to see motorcoaches, converted buses, large commercial vehicles, and the like having lengths of 45 feet and longer.

In order to manage the growing size of these motorcoaches, apparatus and methods have been created to aid drivers operating these types of vehicles. For example, rear-view cameras have been mounted on the rear of motorcoaches to provide added rear visibility. Typically, a monitor is installed in or near the dash in the cockpit of a motorcoach to receive the video signal produced by such camera, thereby enabling a driver to view subject matter behind the motorcoach on the monitor. This feature can be very helpful when backing up a large motorcoach, or viewing vehicles or subject matter behind the motorcoach while driving.

Moreover, as motorcoaches continue to increase in size and sophistication, many include many, if not more, of the amenities and luxuries that can be found in traditional homes. With the increased number of appliances, equipment, and the like, that is provided with these motorcoaches, the management and monitoring of these systems becomes an important issue.

In the past, apparatus and methods for viewing and managing information related to various components in a motorcoach have been provided on dedicated display devices. Usually, this information is not provided in a convenient manner to the driver of a motorcoach. Thus, what is needed is apparatus and methods to integrate the information and present it, in an informative manner, to a driver or user of a motorcoach.

Moreover, in the cockpit of a motorcoach, space on the dash may be scare since many controls, displays, and instrument readouts may be competing for space. Additional display devices may cause excessive crowding of components located on the dash. Therefore, apparatus and methods are needed to display vehicle and coach information on display devices that are already installed for other purposes.

It would be a further advance in the art to use cameras, installed primarily for increasing a driver's visibility, for other functions, such as in a security system similar to those used in many residential homes.

### BRIEF SUMMARY AND OBJECTS OF THE INVENTION

For the purposes of this specification, a motorcoach may be any vehicle that may benefit from an apparatus and method in accordance with the invention, including motorhomes, converted buses, conventional trailers, fifth-wheel trailers, large vans, commercial vehicles such as trucks, buses, and the like. Nevertheless, the term “motorcoach” or “coach” will be primarily used throughout this specification to mean any of the previously mentioned or like vehicles.

An apparatus in accordance with the invention is provided for managing various components of a motorcoach through a rear-view display monitor. For example, such a system may include at least one rear-view camera that provides a video signal comprising captured images of subject matter within the interior or exterior environment of a motorcoach. The video signal may be transmitted and displayed on a monitor. A coach management module in accordance with the invention may be integrated with the camera and monitor to display, simultaneously, coach data with the video signal from the camera.

Coach data may be gathered from various components within the coach using sensors. These sensors may reflect the state of appliances, the outdoor environment, the indoor environment, storage tanks, generators, solar panels, inverters, batteries, and the like. As stated, the camera may simply be a rear-view camera. However, in other embodiments, the camera may be any camera including but not limited to a rear-view camera, a front-view camera, a side-view camera, or an interior camera.

In addition to providing coach data, the monitor and cameras may further be integrated into a security system to provide surveillance inside and outside the motorcoach. In certain embodiments, the motorcoach may include a right-side camera for viewing the right side of the motorcoach and a left-side camera for viewing the left side of the motorcoach. The coach management module may be further configured to display, on the monitor, video input from the right-side camera when the driver triggers a right turn signal. Likewise, video input from the left-side camera may be displayed on the monitor upon triggering a left turn signal.

In order to gather information for display on the monitor, sensors may be located to gather coach data from various motorcoach components. In certain embodiments, a coach bus may be routed from component to component to carry coach data to the coach management module. In addition to displaying coach data, the coach management module may be further configured to simultaneously display vehicle data, with the camera video signals, on the rear-view monitor. Vehicle data may be gathered from various sensors used to sense the status of the engine, transmission, power train, tires, batteries, odometer, fuel, braking systems, and the like. In certain embodiments, a dedicated vehicle data bus may be used to gather the vehicle data for input to the coach management module.

The coach management module may include a presentation module. The presentation module may perform various tasks related to the presentation of data and video on the monitor. For example, the presentation module may enable the overlay of text, icons, symbols, graphic, and the like (hereinafter referred to as “text) onto camera video signals, enable use of split screens to simultaneously display text and video, enable the overlay of one video image onto another video image (e.g. picture on picture), and enable text and video to be displayed on multiple monitors.

In certain embodiments, the presentation module may overlay text onto a background, which may then be overlaid onto a video signal. The background may be transparent, opaque, textured, or the like, in order to make the text stand out from the video signal and improve readability. In addition, if the background is transparent, the video signal may actually be viewed between the symbols and lines of the text, thereby covering as little of the video signal as necessary.

A user input device may also be provided with the coach management module to enable a user to input user-defined parameters, toggle between screens, reset certain parameters, and the like, provided by the coach management module.

In certain embodiments, the coach management module may include a checklist module to display, on the rear-view monitor, a checklist of tasks or “to do” items related to managing the motorcoach. The coach management module may also include a trip data module to calculate traveling data and gather information with respect to trips traveled by the motorcoach.

If more than one camera is used by the coach management module, multiple cameras may be connected to a multiplexer. The multiplexer may be configured to switch between each of the camera as selected or programmed by a user. One or several outputs from the multiplexer may provide video signals from the cameras to the coach management module, to other monitors, or both. In certain embodiments, the multiplexer may be integrated into the coach management module. Additionally, the coach management module may include a power management module to switch off power to certain cameras when they are inactive, thereby conserving energy.

In certain embodiments, apparatus and methods in accordance with the invention may provide a security system integrated into a rear-vision camera and display monitor. In such a system, a security module may share the monitor, with the rear-view camera, to display video from at least one security camera. In certain embodiments, the rear-view camera may actually be integrated into or used as one of the cameras in a multi-camera security system.

In certain embodiments, the security module may include a presentation module to display security camera video, overlay security system information and video onto other video signals, provide split screen capability to simultaneously display video from multiple security cameras, display security system information simultaneously with security camera video, overlay security camera video onto other security camera video, and enable security system information and video to be displayed on multiple monitors.

The security module may include a multiplexer to switch between multiple security cameras, or between security cameras and other cameras, such as the rear-vision camera. The multiplexer may or may not be integrated into the security module. In certain embodiments, the security module may further include a power management module to selectively provide and switch off power to various security cameras when active and inactive, respectively.

### BRIEF DESCRIPTION OF THE DRAWINGS

The foregoing and other objects and features of the present invention will become more fully apparent from the following description, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings in which:

FIG. 1 is a front perspective view illustrating various locations on the exterior of a motorcoach where cameras may be mounted to increase visibility;

FIG. 2 is a rear perspective view illustrating additional locations on the exterior of a motorcoach where cameras may be mounted to increase visibility;

FIG. 3 is a schematic block diagram illustrating various embodiments of screens of video, text information, or a combination thereof that may be displayed on a monitor mounted in the cockpit or other area of a motorcoach;

FIG. 4 is a schematic block diagram illustrating one embodiment of a coach management system that may be installed to display coach and vehicle data along with video received from a rear-view or other camera system;

FIG. 5 is a schematic block diagram illustrating one embodiment of a coach management system that may be installed to display coach and vehicle data along with video received from a multiplexed multi-camera system;

FIG. 6 is

FIG. 7 is a schematic block diagram illustrating one embodiment of a coach management system integrating multiple cameras into a single coach management system;

FIG. 8 is a plan view of a motorcoach, illustrating various locations where exterior and interior cameras may be placed to increase the visibility for a driver of the motorcoach, as well as to provide security surveillance;

FIG. 9 is a plan view of a motorcoach illustrating one embodiment of a vehicle information bus that may be used to gather data from vehicle components such as an engine and transmission;

FIG. 10 is a plan view of a motorcoach illustrating one embodiment of a coach information bus that may be used to gather data from various components within a motorcoach;

FIG. 11 is a schematic block diagram illustrating one embodiment of various hardware or software modules that may provide functionality to the coach management system;

FIG. 12 is a schematic block diagram illustrating one embodiment of a trip data module that may provide various measurements of trip related data and enable a user to define intervals over which to measure data;

FIG. 13 is a schematic block diagram illustrating one embodiment of a security module providing various features and functions for control of a security system;

FIG. 14 is a schematic block diagram illustrating one embodiment of a vehicle monitoring module that may provide data with respect to the engine, transmission, power train, or other vehicle data;

FIG. 15 is a schematic block diagram illustrating one embodiment of a coach monitoring module used to gather data from and control various aspects of a motorcoach;

FIG. 16 is a schematic block diagram illustrating one embodiment of a checklists module that may provide a list of tasks or “to do” items to be performed before, while, or after operating a motorcoach;

FIG. 17 is a schematic block diagram illustrating one embodiment of a presentation module used to provide selected text, text background, screen control and presentation, and text and video mixing in accordance with the invention;

FIG. 18 is a schematic block diagram illustrating one embodiment of an I/O module providing interfacing with an assortment of I/O devices;

FIG. 19 is a schematic block diagram illustrating one embodiment of a multiplexer control module providing a user the ability to configure various multiplexer settings; and

FIG. 20 is a schematic block diagram illustrating one embodiment of a power management module controlling the distribution of power to various devices within the coach management system.

### DETAILED DESCRIPTION OF THE PREFERRED EMBODIMENTS

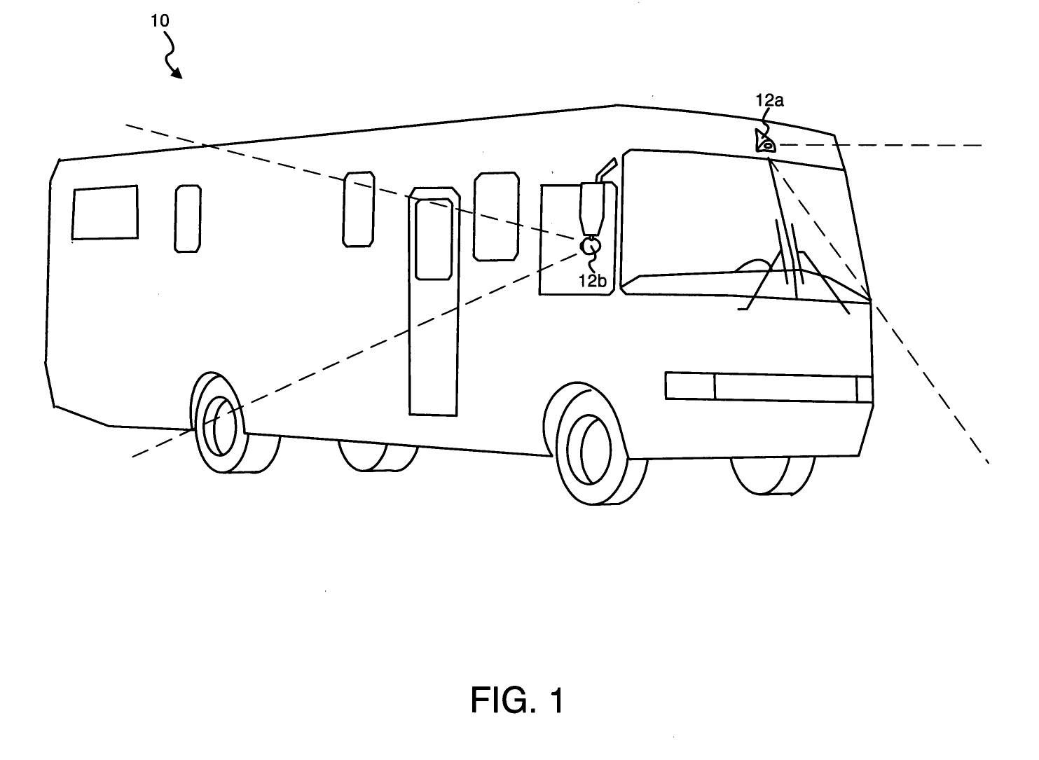

It will be readily understood that the components of the present invention, as generally described and illustrated in the Figures herein, could be arranged and designed in a wide variety of different configurations. Thus, the following more detailed description of the embodiments of systems and methods in accordance with the present invention, as represented in FIGS. 1 through 20, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Many of the functional units described in this specification have been labeled as modules, in order to more particularly emphasize their implementation independence. For example, modules may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. For example, a module of executable code could be a single instruction, or many instructions, and may even be distributed over several different code segments, among different programs, and across several memory devices.

Modules may also be implemented in hardware as electronic circuits comprising custom VLSI circuitry, off-the-shelf semiconductors such as logic chips, transistors, or other discrete components. A module may also be implemented in programmable hardware devices such as field programmable gate arrays, programmable array logic, programmable logic devices or the like.

Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Referring to FIG. 1, a motorcoach 10 may include a plurality of cameras 12 mounted around the periphery thereof. The cameras 12 may improve the visibility of a driver beyond that which he might have without the cameras. In addition to the added visibility, the cameras 12 may provide means to monitor subject matter within the immediate environment of the motorcoach 10.

For example, cameras 12 may be used in a surveillance system to monitor intruders or other persons proximate the motorcoach 10. The cameras 12 may also serve to monitor various items such as entry or exit doors, storage bay doors, and the like. A front-view camera 12a may be used to provide added visibility to a driver when pulling up to a wall or curb that might not otherwise be visible from the driver's seat.

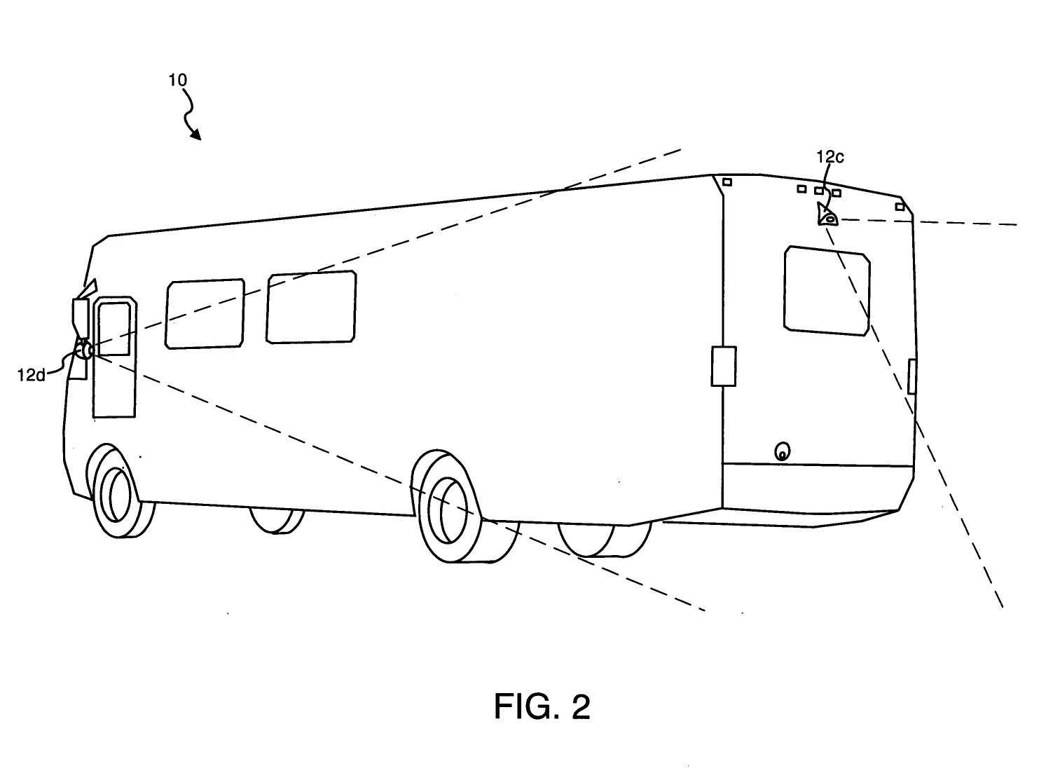

Referring to FIG. 2, as illustrated by a rear view of the motorcoach, a rear-vision camera, 12c may be mounted to view subject matter behind the motorcoach 10. The rear-vision camera 12c may be especially important since the rear of a motorcoach 10 may be quite distant from the cockpit of the driver. Moreover, the rear of the motorcoach 10 may be especially prone to blind spots and thus be likely to collide unintentionally with other objects.

In addition, the rear of a motorcoach 10, as it may extend a significant distance behind a rear axle, may be significantly prone to swing into and collide with objects. Thus, a rear-vision camera 12c may be important to provide added visibility to a driver. In addition, with respect to side-view cameras 12b, 12d, these cameras 12b, 12d provide added visibility along the sides of a motorcoach when making a left or a right turn.

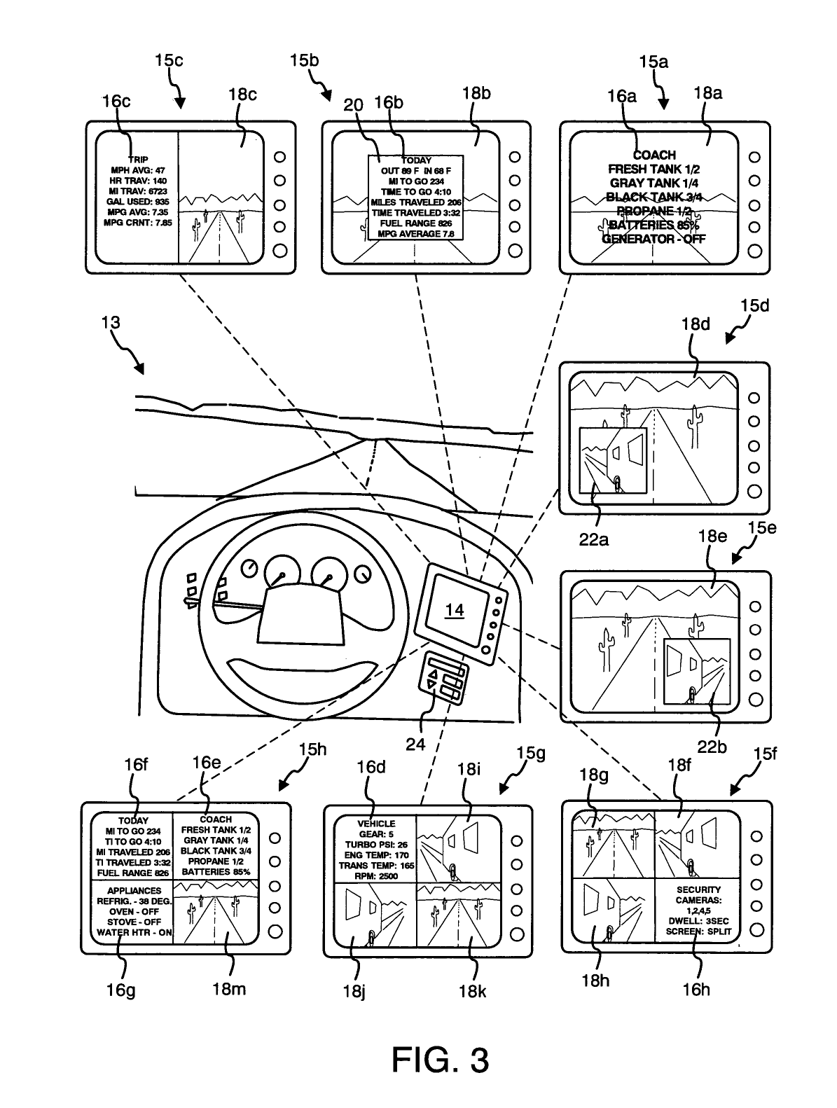

Referring to FIG. 3, the cockpit 13 of a motorcoach 10 may provide various controls to a driver. Within the immediate area of the cockpit 13, a video monitor 14 may be provided to view video signals received from the cameras 12. Because space on the dash in the cockpit 13 may be in high demand for controls, instrumentation, vents, and the like, efficient use of this area 13 may be very important.

Thus, methods wherein a driver may use selected devices for multiple purposes, may be advantageous. For example, a driver might find it advantageous to view vehicle data and motorcoach data not normally provided on a conventional motorcoach dash. Thus, it may be advantageous to provide apparatus and methods to provide this data to a driver.

In accordance with the invention, apparatus and methods are provided to display vehicle and coach data on a rear-view monitor 14. Since it is also to the driver's advantage to see video signals from the cameras 12, apparatus and methods are provided whereby vehicle and coach information may be displayed simultaneously with video signals on the monitor 14.

For example, in one contemplated embodiment, a screen 15a displayed on the monitor 14 may include textual data 16a overlaid onto a video signal 18a. Because of the overlay, the video signal 18a may be viewed simultaneously with the text 16a. Although the text 16a may block, from the driver's view, a portion of the video signal 18a, a significant portion may actually be seen between the symbols and lines of the text 16a. This provides the advantage that the majority of the video signal 18a may still be viewed and the context maintained.

In another embodiment, a screen 15b may include textual content 16b provided on a background 20. The background 20 may be overlayed onto a video signal 18b. In this embodiment, the background 20 may make the text 16b stand out with respect to the video signal 18b. The background 20 may be any desired color, opacity, or texture to make the text 16b stand out from the underlying video signal 18b. In selected embodiments the background 20 may be meshed (e.g. alternating pixels between the background and the text) to intersperse the text 16b with the background 20.

In certain embodiments, the background 20 may be transparent. In other embodiments, the background 20 may be completely opaque. Yet in other embodiments, the background 20 may have a texture that modifies the underlying video image 18b. For example, the background 20 may be such that it blurs the underlying video signal 18b, such that the text 16b may be more easily distinguished from the video signal 18b.

In another embodiment, a screen 15c may be split to provide separate areas for display of a video signal 18c and textual content 16c. The video signal 18c may be resized, cropped, stretched, and the like, in order to fit within the split screen 15c. Likewise, textual content 16c may be similarly modified to fit within a portion of the split screen 15c. In certain embodiments, the textual content 16c may actually be wrapped to fit within a specified area. In another embodiment, a video signal 22a may be overlaid or inset within another video signal 18d. This may be useful for viewing two separate video signals simultaneously. For example, when a driver makes a left hand turn, it may be advantageous to see a left side view of the motorcoach 10 upon making the left hand turn. In certain embodiments, the video signal 22a may be displayed when a driver triggers the left hand turn signal.

Likewise, a video signal 22b of the right side of the motorcoach 10 may be displayed or overlaid onto the video signal 18e when the motorcoach 10 makes a right hand turn. In reality, it may be advantageous to have one video signal 22a, 22b overlaid onto another video signal 18d, 18e in a variety of different situations. For example, a driver may simply desire to see views from two separate video cameras 12 simultaneously.

In another embodiment, a screen 15f may be split to display a plurality of video signals 18f, 18g, 18h. In addition, textual information 16h may also be displayed in designated areas of the screen 15f. For example, when using the rear-vision monitor 14 in a security system, several video signals 18f, 18g, 18h may be displayed simultaneously to monitor multiple views outside or inside a motorcoach 10. In addition, textual or symbolic information may be provided with respect to the functioning of the security system. When the vehicle is in reverse, default controls may override all inputs, assuring a clear rearward view on the monitor.

In another contemplated embodiment, a screen may require that a driver or other person enter a password to access the integrated coach management system. A password may be assigned to a driver of a motorcoach 10, or to a technician or supervisor of the motorcoach 10 or the coach management module.

In another embodiment, screen 15g may display various camera angles or views 18i, 18j, 18k of a motorcoach 10 while it is moving. The various views 18i, 18j, 18k of the motorcoach 10 may include, a left side 18i, a right side 18j, and the rear 18k, for example. In addition, textual information 16d providing vehicle data may be displayed simultaneously with the video images 18i, 18j, 18k to provide data to the driver.

In yet another embodiment, a screen 15h may include multiple views 16e, 16f, 16g of vehicle and coach data for review by the driver. In reality, any of the embodiments or configuration as depicted in the screens 15 may be mixed and matched in any one of numerous different combinations. The screens 15, as illustrated, are presented by way of example, and are in no way intended to limit the scope of the present invention.

An input device 24 may be provided with the display monitor 14 to enable a driver to selectively control text 16 and video 18 displayed on the monitor 14. For example, an input device 24 may enable a user to toggle between different screens 15. The input device 24 may also enable a driver to input or modify data displayed on the screens 15. Input data may be used to perform various calculations with respect to the motorcoach 10 in order to be displayed on the monitor 14. In certain embodiments, the input device 24 may allow a driver to view various subsets of information within particular screens of textual information 16. Moreover, the input device 24 may also enable a driver to reset, select, or configure particular values that may be displayed as text 16.

In selected embodiments, no text may be displayed while a driver is operating a motorcoach 10 to prevent distractions to the driver. However, in the event of a monitored system warning or failure of some component of the motorcoach 10, such as a vehicle maintenance warning concerning the engine, transmission, or a tire on the vehicle 10, an appropriate icon or symbol may be displayed on the screen. In addition, in selected embodiments, an audible buzzer or other sound may occur under certain conditions, or a light signal may be displayed to notify the driver of a condition.

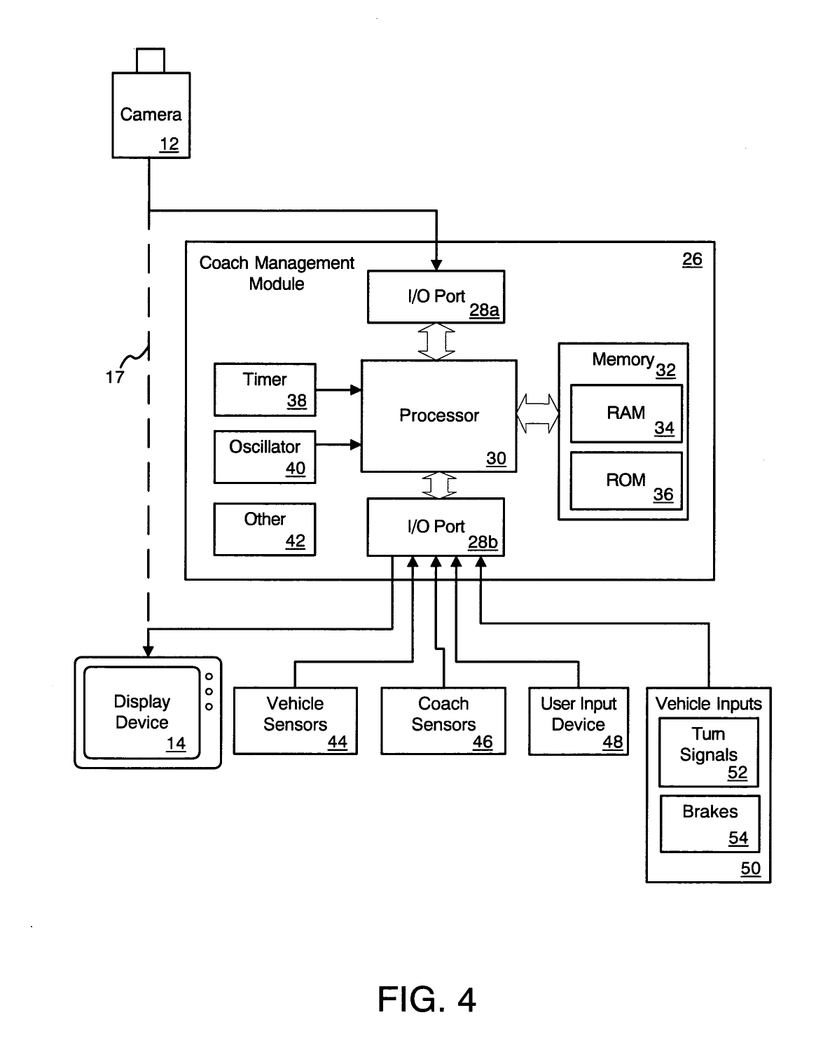

Referring to FIG. 4, a coach management module 26 may be configured to intercept and modify a video signal transmitted between a legacy camera 12 and monitor 14. The coach management module 26 may serve to display vehicle and coach data on the display device 14 simultaneously with video signals received from the camera 12. For example, a motorcoach 10 may already be equipped with a rear-view camera system comprising a camera 12, a cable 17 or other transmission means 17, and a display device 14. The coach management module 26 may be designed to intercept the video signal transmitted therebetween. Upon interception, the coach management module 26 may then mix vehicle and coach data with the video signal for display on the monitor 14.

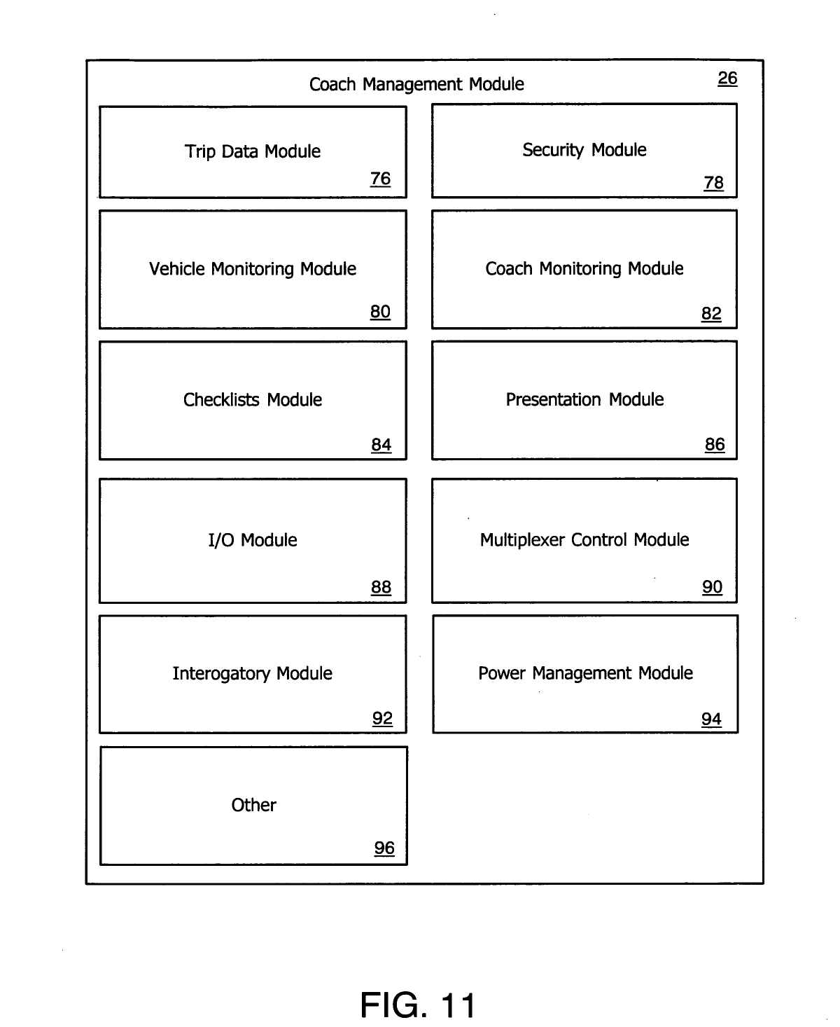

The coach management module 26 may include various components providing various functions. For example, an I/O port 28a may be included to receive a video signal from the camera 12. A processor 30 may receive the video signal and modify it to include the vehicle and coach data as described in the description of FIG. 3. The coach management module 26 may also include a memory module 32, which may include volatile and non-volatile memory 32 such as random access memory 34 and read-only memory 36. Read-only memory 36 may include PROM, EPROM, or EEPROM, for example. The memory 32 may store executable and operational data processable by the processor 30. Added details regarding the executable and operational data is provided in the description of FIG. 11.

The coach management module 26 may include other components such as a timer 38, an oscillator 40, or other components 42 providing various features and functions. In fact, many of the components within the coach management module 26 may be provided by one of numerous microcontrollers currently available.

An I/O port 28b may receive various inputs and provide various outputs. For example, the I/O port 28b may provide a mixed video signal containing video and textual information 16 to the display device 14. With respect to inputs, the I/O port 28b may receive data from various vehicle sensors 44, coach sensors 46, user input devices 48, vehicle inputs 50, and the like.

Vehicle sensors 44 may include sensors 44 whose primary task is to gather data from the engine, transmission, power train, and like mechanisms of a motorcoach 10. Coach sensors 46 may include sensors whose primary responsibility is not to gather vehicle data, but to gather data from components providing amenities or necessities of the living environment of the motorcoach 10. Vehicle inputs 50 may include those inputs 50 that enable interruption of the system 26. For example, turn signals 52 may interrupt the coach management module 26, thereby triggering the display of the right or left-hand side of the motorcoach 10. Likewise, brakes 54 or a reverse gear of the motorcoach 10 may trigger the display of the rear, or some other view, of the motorcoach 10.

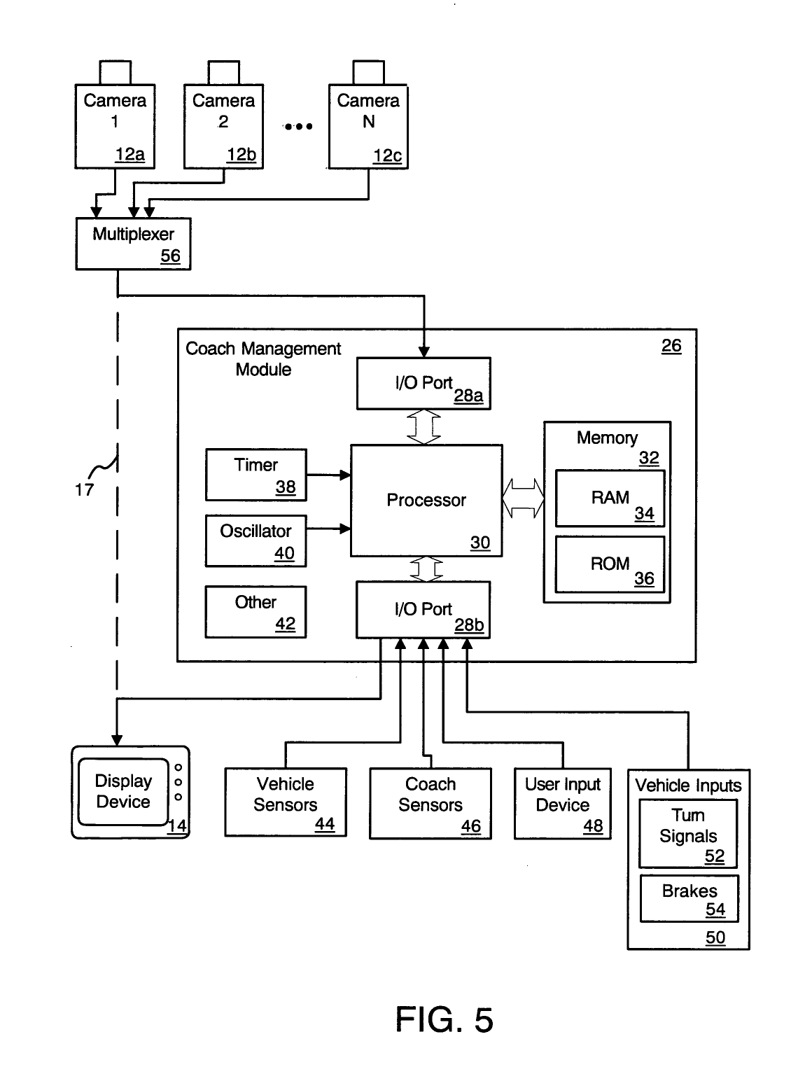

Referring to FIG. 5, in another embodiment, cameras 12a, 12b, 12c, may or may not be multiplexed together by a multiplexer 56. The multiplexer 56 may serve to switch between the cameras 12a, 12b, 12c, thereby providing a video signal from at least one of the cameras 12a, 12b, 12c to a display device 14, or multiple display devices 14. A coach management module 26 providing the functionality as described in FIG. 4, may be inserted between the multiplexer 56 and the display device 14 to mix vehicle and coach data with the video signal transmitted therebetween.

Thus, although the multiplexer 56 may in fact be switching between video signals received from each of the cameras 12a, 12b, 12c, the coach management module 26 may be configured to display vehicle data, coach data, or both simultaneously with whatever video signal is being displayed. A rear-vision override feature may default to a full, rear view whenever the motorcoach operates in reverse gear.

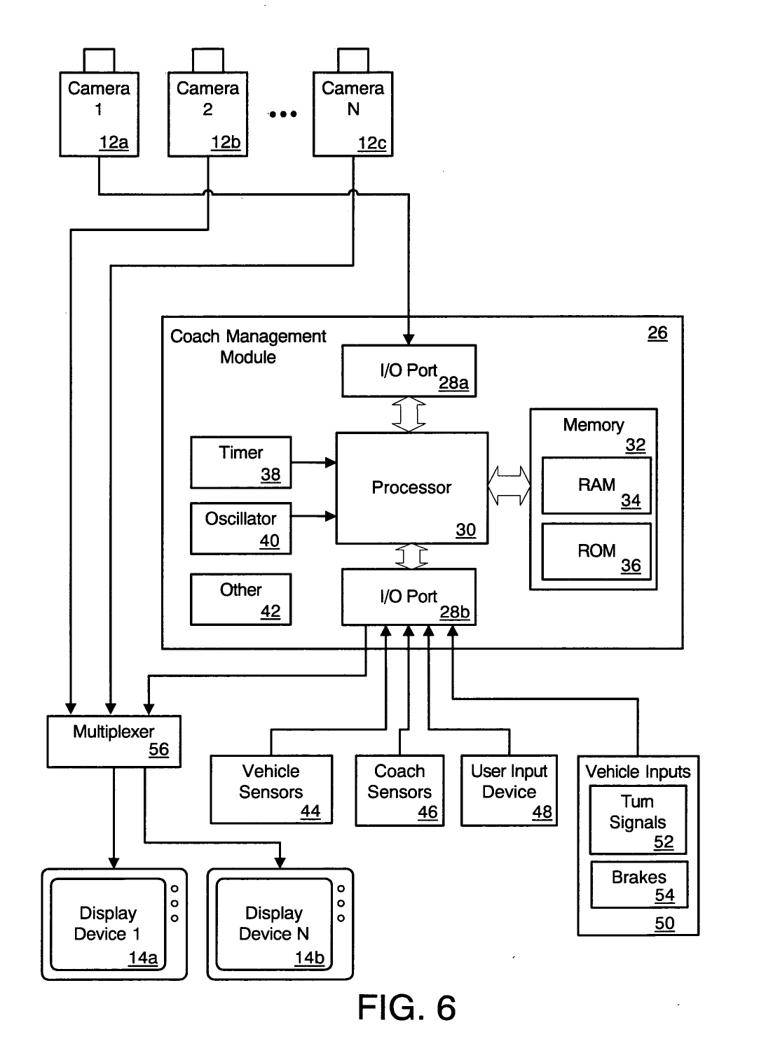

Referring to FIG. 6, in another embodiment, a multiplexer 56 may receive as one of its inputs a video signal from the coach management module 26. The coach management module 26 may mix vehicle and coach data with a video signal received from a first camera 12a, such as a rear view camera 12a. Other video signals may be received by the multiplexer 56 from other cameras 12b, 12c. The multiplexer 56 may switch between the cameras 12a, 12b, 12c, thereby providing a video signal from at least one of the cameras 12a, 12b, 12c to a display device 14a, or multiple display devices 14a, 14b.

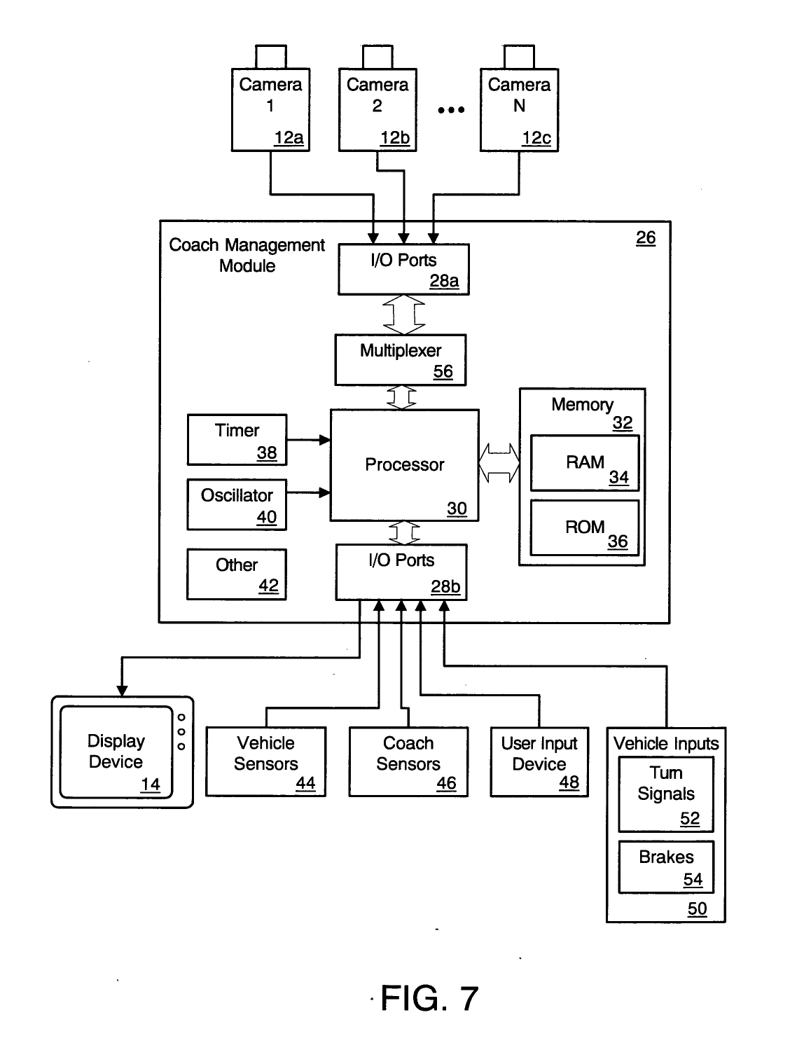

Referring to FIG. 7, in another embodiment, the coach management module 26 may function to integrate multiple cameras 12a, 12b, 12c into a single system . For example, video signals from multiple cameras 12a, 12b, 12c may be received by an I/O port 28a or ports 28a provided by the coach management module 26. These video signals may be routed to a multiplexer 56, also integrated into the coach management module 26. As described previously, the multiplexer 56 may serve to switch between any of the cameras 12a, 12b, 12c. From the multiplexer 56, a selected video signal may be fed to the processor 30 where it may be combined with vehicle or coach data. An I/O port 28b may then output the processed signal to a display device 14.

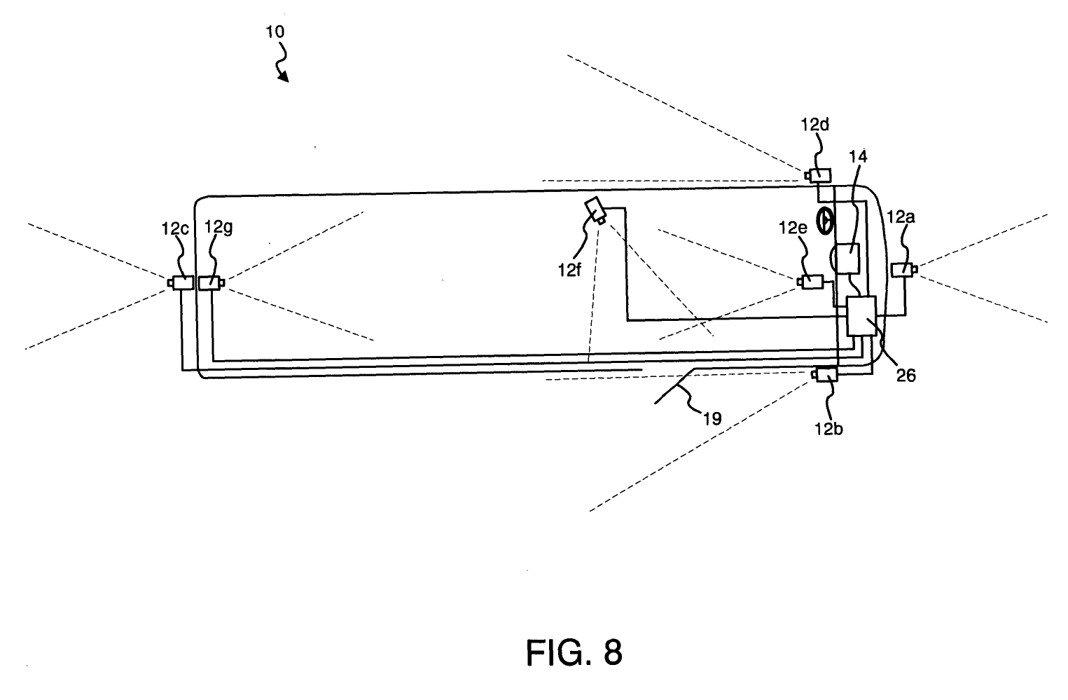

Referring to FIG. 8, cameras 12 may be positioned at various locations inside or outside a motorcoach 10. For example, exterior cameras, such as a front-view camera 12a, a rear-view camera 12c, or side-view cameras 12b, 12d, may be mounted around the periphery of a motorcoach 10. The cameras 12a-d may be used to increase the visibility of a driver of the motorcoach 10, used as part of a security system, or both.

Likewise, selected cameras 12e, 12f, 12g may be mounted within the interior of a motorcoach 10. These cameras may provide a driver the ability to monitor subject matter within the motorcoach 10 while stationary or moving, or may be integrated into a security system. For example, in one embodiment, the interior of a motorcoach 10 may include a rear-view camera 12g, a front-view camera 12e, and various other (e.g third, fourth etc.) cameras 12f that may be used to monitor an entry door 19, a crib, or other location or feature.

Each of the cameras 12 may be operably connected to a coach management module 26 located within the motorcoach 10. The coach management module 26 may serve to switch between each of the cameras 12, as needed, and provide an output video signal to a display monitor 14. The coach management module 26 and the display monitor 14 may be located anywhere within the interior of the motorcoach 10 and the monitor may display results from one or more cameras 12 at any time.

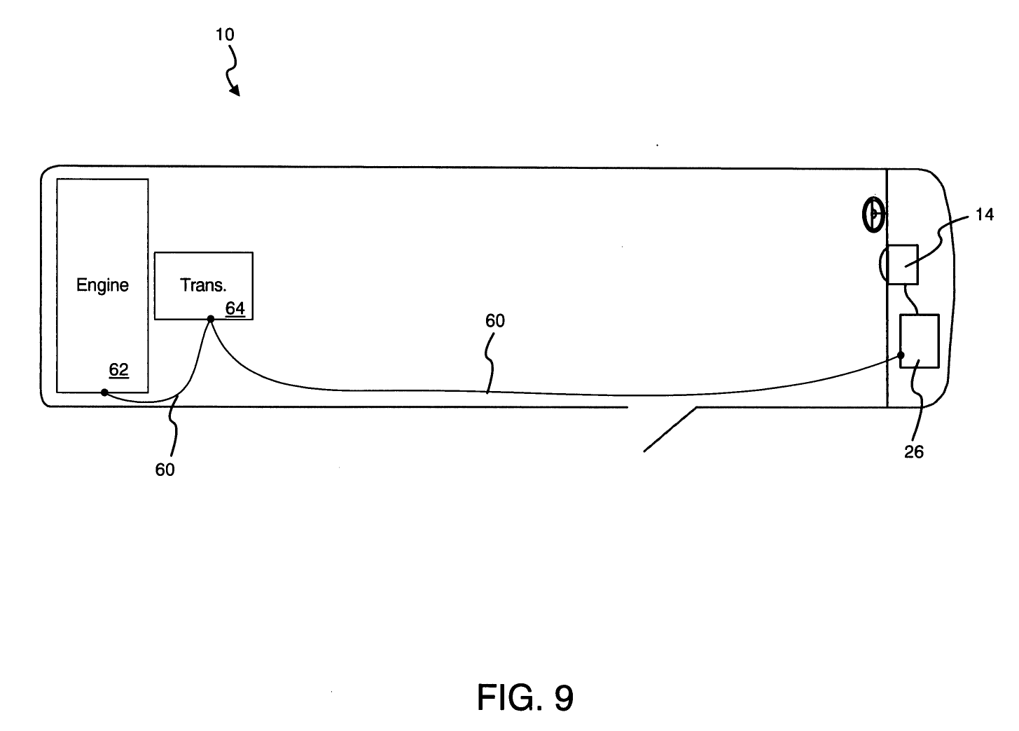

Referring to FIG. 9, the coach management module 26 may gather vehicle data from various vehicle sensors 44. The vehicle sensors 44 may be located in, on, or near various vehicle components such as a vehicle engine 62 and transmission 64. In order to simplify the transmission of vehicle data to a central location and to reduce the number of individual wires to various components, a bus 60 may be used to connect or “daisy-chain” together various components 62, 64. For example, particular protocols, such as the SAE J1708 and SAE J1587 data bus protocol may be used to gather data from various vehicle components. Newer data bus protocols used for gathering information from vehicle components, such as that described by the SAE J1939 standard, may be used.

In any event, the coach management module 26 may utilize the vehicle data bus 60 to gather vehicle data. In certain embodiments, the vehicle data bus 60 may be a proprietary bus used solely with the coach management module 26. In other embodiments, the vehicle data bus 60 may simply be a universal data bus, adhering to standardized protocols, provided with the chassis of a motorcoach 10.

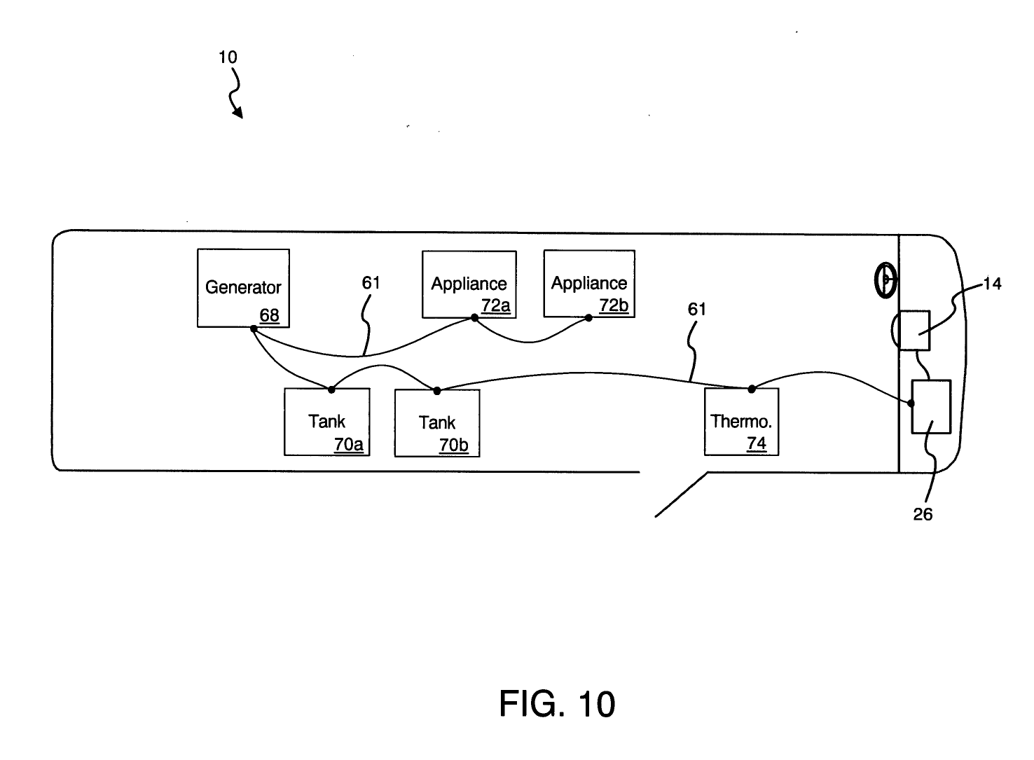

Referring to FIG. 10, in a similar manner, a coach data bus may be used to gather data from a plurality of coach components 68, 70, 72, 74. For example, a coach data bus 61 may gather temperature data from a thermometer 74, level data corresponding to fresh water and sewer tank 70 (grey water, black water) levels, data corresponding to the operation of a generator 68, or data corresponding to any of various appliances 72 (e.g. stove, refrigerator, furnace, water heater, lighting, TV, etc.) located within the interior of a motorcoach 10. Using a standardized bus 61 may reduce the necessity to route dedicated wires to each of the components 68, 70, 72, 74. Apparatus and methods in accordance with the invention need not use a standardized bus 61. However, the use of a bus 61 may simplify the process of gathering data from individual components 68, 70, 72, 74 within the motorcoach 10.

The coach management module 26 may take the data gathered from each of the components 68, 70, 72, 74 and mix the data with video signals received from one or several of the cameras 12. Once mixed, or integrated, the video signals and coach data may be displayed simultaneously on the display monitor 14.

Referring to FIG. 11, the coach management module 26 may be divided into various subsystems. These subsystems may be implemented exclusively with hardware located within the coach management module 26, or they may be implemented using a combination of hardware and software stored within memory 32.

For example, in selected embodiments the coach management module 26 may include a trip data module 76 to display trip data with respect to trips taken by a motorcoach 10, a security module 78 to integrate cameras 12 into a motorcoach security system, a vehicle monitoring module 80 to monitor vehicle data reflecting the mechanical functioning of a motorcoach 10, and a coach monitoring module 82 to monitor coach data reflecting the state of components or appliances within a motorcoach 10.

In addition, the coach management module 26 may include a checklist module 84 providing a “to do” list of tasks to complete before operating a motorcoach 10, a presentation module 86 to present data and video simultaneously on a monitor 14, an I/O module 88 to provide inputs and outputs to a plurality of devices, a multiplexer control module 90 to control video received from a plurality of cameras 12, an interrogatory module 92 to receive inputs from a user, a power management module 94 to control power distribution to various devices, and other modules 96.

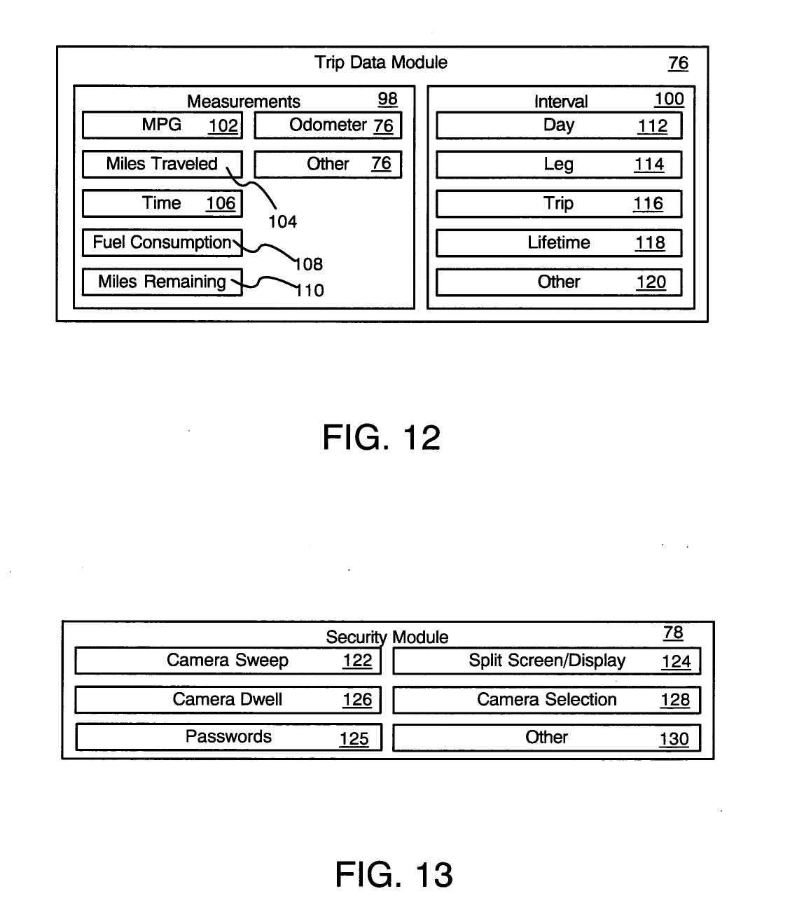

Referring to FIG. 12, a trip data module 76 may provide data relating to trips or travel undertaken by the motorcoach 10. In certain embodiments, the trip data module 76 may include a measurements module 98 and a interval module 100. Ameasurements module 98 may be configured to provide various measurements with respect to trips or travel of the motorcoach 10.

For example, the measurements module 98 may provide, on the monitor 14, the average or instantaneous miles per gallon 102 of the motorcoach 10, the total miles traveled 104, the time 106 traveled, the fuel consumption 108 of the motorcoach 10 over a specified interval, miles remaining 110 to arrive at a selected destination, a current vehicle odometer reading 76, or other selected measurements 76 such as average or current temperature, range of the motorcoach 10 at current fuel levels, average or instantaneous miles per hour, current location calculated by a GPS, navigation system information (travel directions), tour guide information with respect to restaurants, lodging, history, points-of-interest, and events corresponding to a location of the motorcoach 10, and the like.

Any or all of the measurements calculated by the measurement module 98 may be calculated, as desired, over a selected time or distance interval 100. For example, measurements 98 may be calculated for a particular day 112, a selected leg 114 of a trip, an entire trip 116, over the lifetime 118 of the motorcoach 10, or some other interval 120, as programmed by a user or designer. Data from the trip data module 76 may be organized in any of a number of ways. For example, referring briefly back to FIG. 3, a screen 15c illustrates one of many possible embodiments to display trip data.

Referring to FIG. 13, the coach management module 26 may include a security module 78. The security module 78 may function to integrate each of the cameras 12 into a motorcoach security system. The security module 78 may include various features which may or may not be present in common residential security systems. For example, a user may be able to program the camera sweep 122 of the security system. Camera sweep 122 may refer to the sequence or order of camera images that are viewed through the monitor 14.

In addition, a user may manually set display options 124 for the security module 78. In certain instances, the user may desire to see a split screen displaying images from multiple cameras 12 simultaneously. In other cases, the user may desire to see only a single camera image filling the entire screen 15 of the display 14.

Passwords 125 may be required on password screens to provide different access levels to different types of users. For example, in selected embodiments, drivers, mechanics, or supervisors may have different passwords to access the coach management module 26. Options may be provided to allow different persons to choose desired operations of the coach management module, depending on the level of access provided thereto, to enter passwords, to change passwords, and the like.

Likewise, the security module 78 may enable a user to set camera dwell 126. Camera dwell 126 refers to a time interval wherein a particular camera image is displayed before switching to an image from another camera 12. The security module 78 may also enable a user to select 128 cameras used in the security system. For example, a user may select only exterior cameras 12a-d, or interior cameras 12e-g, for use in a security system. Likewise, the security module 78 may provide other features 130 and functions 130, such as motion sensors, to control and operate the security module 78.

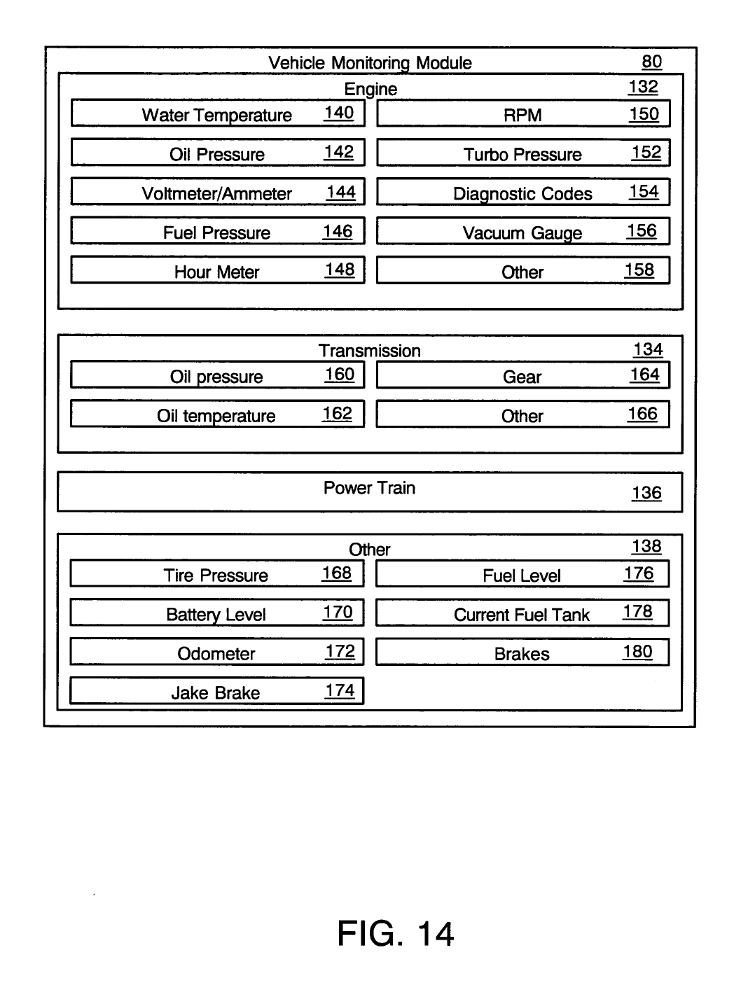

Referring to FIG. 14, a vehicle monitoring module 80 may be programmed or configured to gather vehicle data from vehicular components of the motorcoach 10. By vehicle data, is meant data reflecting the function and operation of vehicle subsystems and components such as the engine 132, transmission 134, power train 136, or the like, not closely related to coach or living components.

For example, the vehicle monitoring module 80 may collect data pertaining to the engine 132. Engine data 132 may include engine water temperature 140, engine oil pressure 142, current or voltage levels indicated by a volt meter or an ammeter 144, fuel pressure 146, or an hour meter 148 indicating the amount of time the engine 132 has been operated. In addition, engine data 132 may also include instantaneous revolutions per minute 150 of the engine 132, turbo pressure 152 of a turbo booster, selected diagnostic codes 154 indicating status or problems of various vehicle components, vacuum readings 156, or other engine data 158, such as manifold temperature.

Transmission data 134 may include, for example, transmission oil pressure 160, transmission oil temperature 162, transmission gears 164 selected and attained, or other desired transmission data 134, such as the retarder temperature, power take off temperature, rotating speed of the transmission shaft, and the transmission fluid level. The vehicle monitoring module 80 may also gather data (e.g. speed, force, stress, etc.) from any or all intervening power train components 136 located between the transmission and points where power is transferred to wheels and tires.

Other vehicle data 138 may include data gathered from sensors able to monitor tire pressure 168, battery charge levels 170, odometer readings 172 of the motorcoach 10, data from compression brakes 174 or air brakes 180, and the like. With respect to tires 168, in selected embodiments, a user may be able to configure tire warning conditions by setting desired threshold values on a per-axle basis. For example, a user may be able to set cold inflation tire pressure, a low pressure warning threshold, a pressure deviation warning level, and a high temperature warning. In selected embodiments, a user may be able view a log screen showing occurrences of warnings or alerts with respect to the tires. The log screen may show the date, time, and type of alert that occurred in each instance, for example.

Other vehicle data 138 may include fuel levels 176 of one or several fuel tanks of the motorcoach 10, data reflecting the current fuel tank 178 being used, or other data 181 with respect to the brakes, fluid lines, reservoirs, and the like for water, air, lubricants, and fuels of the motorcoach 10. In other embodiments, the coach management module 26 may display to a user, operator, mechanic, or supervisor of the motorcoach 10 the date and time, a vehicle identification number, an indicator of the readiness of the engine to start, the engine load as a function of current torque versus maximum torque, the state of a retarding (engine power stopping) device, total time of power take off operation, or the acceptability of a level of water or moisture in the fuel. The data 132, 134, 136, 138 gathered by the vehicle monitoring module 80, as presented, is in no way an exhaustive list of data that may be gathered and analyzed, and is only presented by way of example.

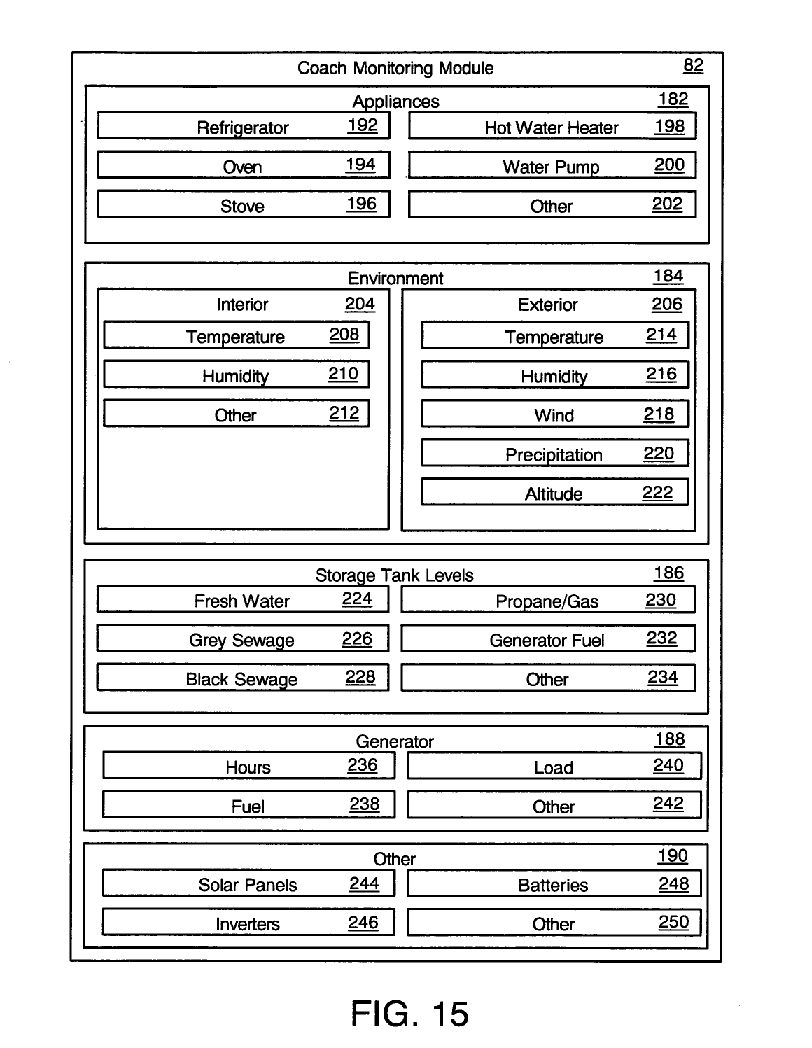

Referring to FIG. 15, the coach management module 26 may include the coach monitoring module 82 to gather data from various motorcoach 10 components. By coach data, is meant components that are not particularly crucial to the movement and maneuverability of the motorcoach 10, but rather data relating to components providing amenities in the motorcoach's living quarters. For example, data regarding fuel tanks, power, batteries, and the like corresponding to the living space may be presented.

For example, the coach management module 26 may gather data from various appliances 182 within the motorcoach 10. As appliances 182 become more advanced and standardized with respect to data input and output features, apparatus and methods are needed to integrate these appliances 182, and provide monitoring and control. Appliances 182 that may be monitored and controlled by the coach monitoring module 82 may include refrigerators 192, microwave and conventional ovens 194, stoves 196, hot water heaters 198, water pumps 200, or other appliances 202 such as pressure expansion tanks, indoor or outdoor lighting, motorized awnings, automatic slide outs, motorized entry or exit steps, automated antennas, vents, central vacuums, dishwashers, trash compactors, televisions, audio and video components, air conditioners, heaters, thermostats, clothing washers and dryers, and the like. For example, with respect to a hot water heater 198, the coach monitoring module 82 may determine whether a pilot light is lit, current water temperature, and the like.

The coach monitoring module 82 may be configured to measure environmental data 184 corresponding to the interior 204 or exterior 206 of a motorcoach 10. For example, within the interior 204 of the motorcoach 10, characteristics such as temperature 208, humidity 210, or other environmental characteristics 212 may be measured. Exterior measurements of the environment 184 outside the motorcoach 10 may also be measured For example, outside temperature 214, humidity 216, wind velocity and direction 218, amounts of precipitation 220, vehicle altitude 222, or other characteristics may be measured.

The coach monitoring module 82 may also gather data corresponding to storage tank levels 186. For example, data may be gathered with respect to fresh water levels 224, grey sewage levels 226, black sewage levels 228, propane or gas levels 230, quantities of generator fuel 232 if stored in a tank independent from engine fuel, or other tank levels 234, as needed. With respect to a generator 188, data such as total hours 236 of generator operation, generator fuel levels 238, energy loads 240 placed on the generator, or other generator data 242, may be gathered.

It is also contemplated that a user, by way of the coach monitoring module 82, may be able to control various functions of coach components within the motorcoach 10, such as turning the generator on or off, using a user input device 24. Other data 190 which may be gathered by the coach monitoring module 82 may include solar panel data 244 indicating solar panel current or voltage levels, data corresponding to inverters 246 used to convert DC power to AC power, data corresponding to battery energy levels 248 used to power coach components, or other coach data 250. The coach components mentioned herein are not intended to be an exhaustive list of every coach component, but are presented herein only by way of example of monitored components in accordance with the invention.

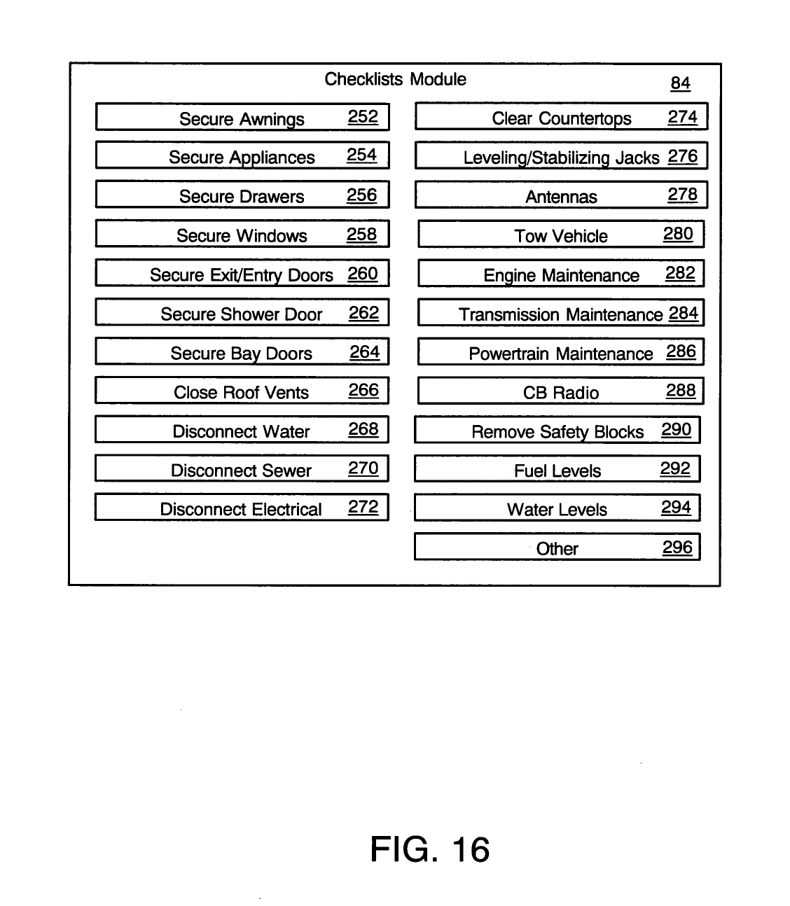

Referring to FIG. 16, the coach monitoring module 82 may include a checklist module 84. While a motorcoach 10 may include many amenities provided in traditional residential homes, many of the same amenities are modified to function in a motorcoach 10 environment. For example, certain components or amenities may be characterized by a deployed state for use when a motorcoach 10 is parked or stationary. Likewise, the same components or amenities may have a secured or retracted state when the motorcoach 10 is moving. Thus, a user may either manually, or with the help of automation, employ components within one of these two states.

A checklist module 84 may remind or provide a “to do” list of tasks that should be performed before moving, parking, or both, a motorcoach 10. For example, before driving or moving a motorcoach 10, the checklist module 84 may remind a driver to secure various components of the motorcoach 10. For example, a driver may be reminded to secure or retract awnings 252, appliances 254, drawers 256, windows 258, exit and entry doors 260, shower doors 262, storage bay doors 264, and the like. In addition, the checklist module 84 may remind a driver or user to close overhead roof vents 266 on the motorcoach 10, disconnect waterlines 268, disconnect sewer hoses 270, and disconnect electrical cords 272 from stationary motorcoach hookups. Some items in such a checklist may have sensors to report warnings if a vehicle engine starts with the devices deployed. For example, jacks and antennas may be damaged if deployed when a vehicle is in motion. Any control system, service, device, or the like may be included in this “pre-flight” checklist. In addition, selected items displayed in the “pre-flight” checklist may be selected by a driver or other user to display additional data or initiate actions with respect to the items.

The checklist module 84 may warn of deployed positions or simply remind a driver to retract components, such as leveling or stabilizing jacks 276 and antennas 278. The checklist module 84 may remind a driver to verify that a towed vehicle 280 is properly connected, and verify that engine 282, transmission 284, and power train 286 maintenance has been properly conducted.

Other reminders that may be provided by the checklist module 84 may include verifying that a CB radio 288 is functioning, safety blocks 290 have been removed from tires, fuel levels 292 are sufficient for a planned trip, water levels 294 are sufficient, and other tasks 296. The checklist module 84 may also remind a user to check oil levels, grease levels, lubricant levels, various fluid levels, tire tread depth and condition, tire pressure, headlights, running lights, tail lights, lights on a towed vehicle, condition of belts, condition of water and fuel hoses, tolerance of components such as universal joints, coolant and antifreeze levels, battery water level, and the like.

In other embodiments, maintenance screens may be used to assist the driver or mechanic to identify, manage, and schedule timely or regularly scheduled work necessary or desired for a motorcoach 10. Schedules can be set to trigger a warning for needed maintenance, and records for maintenance already performed may be maintained. For example, in selected embodiments, maintenance screens may keep track of time or miles traveled since a last oil change, a change of a fuel or air filter, transmission fluid change, power take off oil change, differential oil change, hydraulic oil change, and the like.

Log and tracking screens may be used to review historical data related to specific events with respect to a motorcoach 10. A driver, mechanic, or supervisor may view a detailed summary of actions and events that have occurred to the motorcoach 10 or to the coach management module 26. In certain embodiments, a menu may be provided to enable a driver, mechanic, or supervisor to identify particular log information of interest and to transition directly to a screen containing the desired information.

For example, a warning log screen may serve to record and display warnings and alerts that have occurred due to various parameters reaching unacceptable or threshold values for an engine, transmission, or other vehicle or coach component. The warning log screen may display the date, time, and the type of alert for each occurrence. Likewise, a maintenance log screen may be used to track events related to the maintenance of a vehicle. This listing of events may be used by a mechanic, driver, or supervisor, as needed. A maintenance log may list the date, time, a user who performed the maintenance, and event type. Event types may include when engine oil was changed, a fuel filter was replaced, tires were inspected, and the like.

Similarly, a user access log screen may track and record the date, time, and users who have accessed the coach management module 26. A customer service screen may list phone numbers, contact information, email addresses, web sites, and the like if a user has trouble with a motorcoach 10 or the coach management module 26. In other embodiments, a compass or temperature screen may display the current direction a vehicle is traveling or the current temperature inside or outside a vehicle.

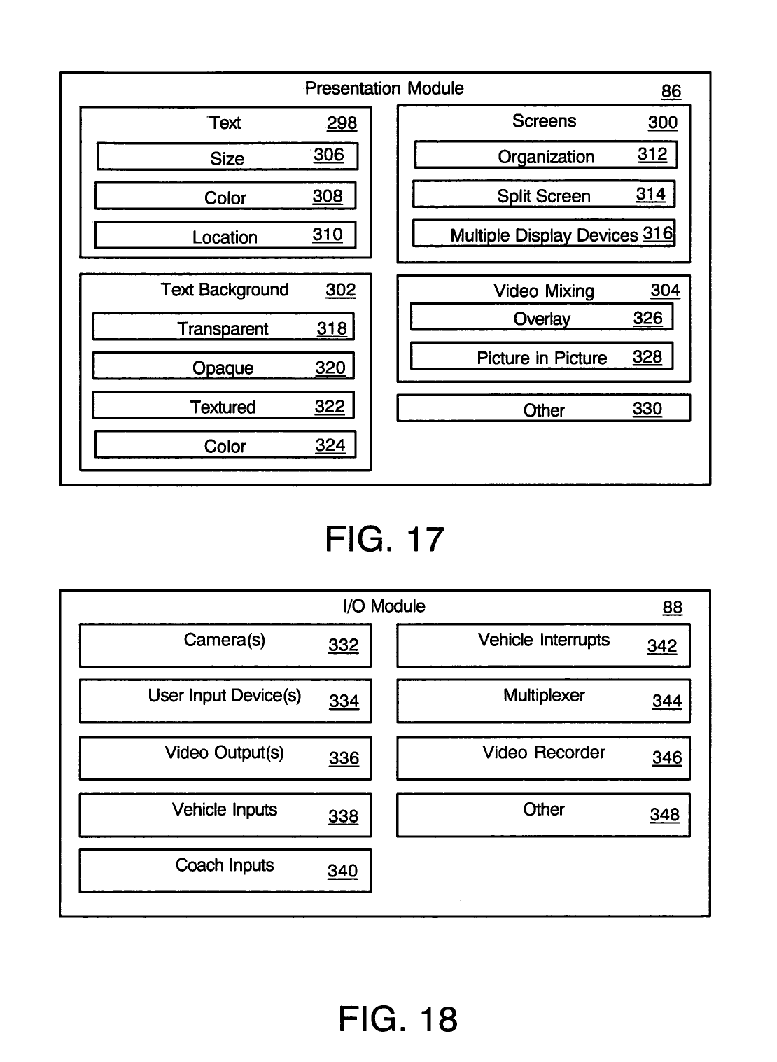

Referring to FIG. 17, while again referring generally to FIG. 3, a presentation module 86 may be provided to control the presentation of video and textual and symbolic information 16 on the monitor 14. For example, a presentation module 86 may be responsible for presenting text 298, backgrounds 302 for the text, organizing and displaying screens 300, and mixing 304 video and textual information, toggling between screens, adjusting contrast, tint, color, and dimensions of screens. The presentation of text 298 may include selecting proper size 306, color 308, and location 310 of text on the monitor 14, as well as text spacing, margins, font, bolding, justification, case, and the like. Selecting a background 302 for the text may include controlling the transparency 318, the opacity 320, the texture 322, dimensions, color 324, and the like, of the background 302.

The presentation module 86 may determine the organization 312 of screens 300, provide split screen 314 capability, and enable the presentation of screens 300 on multiple monitors 316. In addition, the presentation module 86 may enable mixing 304 of video with text 298, or video with other video. The video mixing module 304 may enable the overlay 326 of text onto a video signal, provide picture-in-picture capability 328, or other video mixing capabilities.

Referring to FIG. 18, an I/O module 88 may receive and transmit various signals to and from components of the coach management system 26. For example, ports may be provided to communicate with one or a plurality of cameras 332 and receive input from a user input device 334. In addition, the I/O module 88 may provide one or several video outputs 336 to connect with one or a plurality of monitors 14. Input ports may be provided for vehicle inputs 338, such as the vehicle information bus 60 described in association with FIG. 9. Likewise, input ports may be provided for coach inputs 340, such as the coach data bus 61 described with respect to FIG. 10.

The I/O module 88 may include input ports for vehicle interrupts 342 , such as interrupts provided by the triggering of turn signals 52, or brakes 54. Inputs and outputs may be provided to receive video signals from a multiplexer 344 or provide control signals to the multiplexer 344. The I/O module 88 may provide an output to a video recorder 346, such that a user may record video signals received from cameras 12, such as when used in a security system. Likewise, other inputs and outputs 348 may be provided as needed.

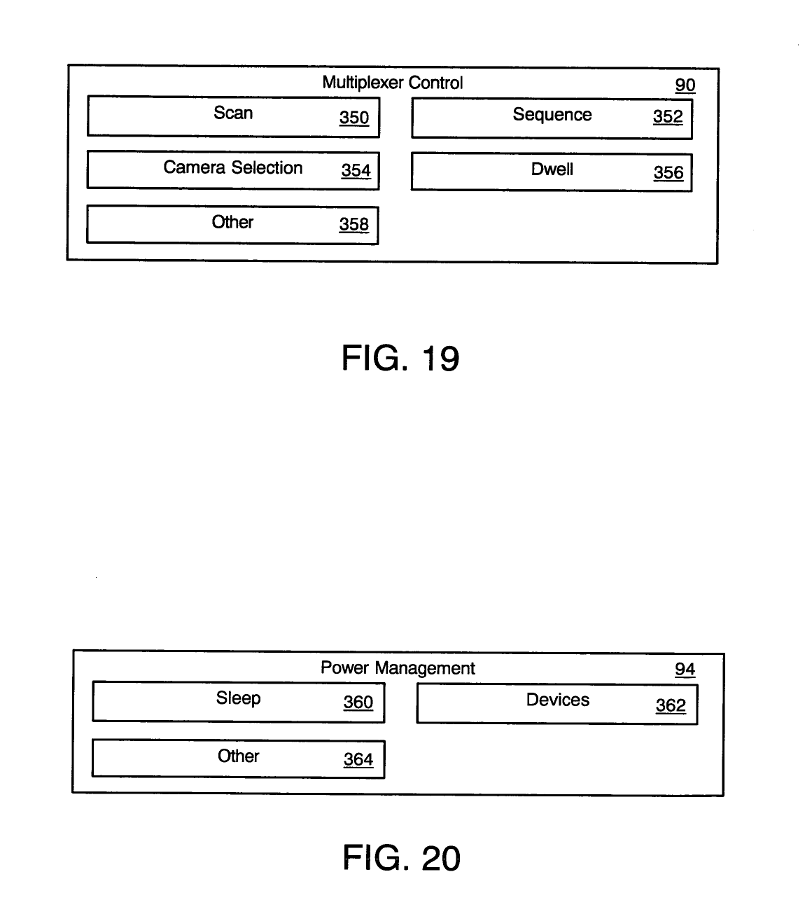

Referring to FIG. 19, a multiplexer control module 90 may provide the ability to control a multiplexer 56 used to switch between cameras 12. For example, a user may select a scan function 350 enabling a user to scan between cameras 12. A user may also be able to select the sequence 352 of cameras 12 that are scanned. In addition, a user may select 354 or unselect 354 particular cameras 12 that are viewed. In other embodiments, a user may select the dwell time 356 used to display a particular video signal before switching to a subsequent video signal. Likewise, the multiplexer control module 90 may include other functions 358 as needed.

Referring to FIG. 20, a power management module 94 may be included to selectively provide power to components of the coach management system. For example, the power management module 94 may enable certain devices to be switched off, or to fall into a sleep state 360, when the devices are inactive or not being used. Other features of the power management module 94 may include enabling a user to select power management features corresponding to specific devices 362. Likewise, the power management module 94 may include other features 364 to provide effective power management of components in the coach management system.

The present invention may be embodied in other specific forms without departing from its essence or essential characteristics. The described embodiments are to be considered in all respects only as illustrative, and not restrictive. The scope of the invention is, therefore, indicated by the appended claims, rather than by the foregoing description. All changes within the meaning and range of equivalency of the claims are to be embraced within their scope.

1. A system for managing subsystems of a vehicle through a rear vision display monitor, the system comprising:
a first camera for providing a first video signal comprising captured images of subject matter within the environment of a motorcoach;
a monitor for displaying the first video signal; and
a coach management module configured to simultaneously display, with the first video signal, management information relating to the motorcoach on the monitor.

2. The system of claim 1, wherein management information is selected from a sensor reflecting the state of at least one of the group consisting of an appliance, outdoor environment, indoor environment, storage tank, generator, solar panel, inverter, and battery.

3. The system of claim 1, wherein the first camera is selected from the group consisting of a rear view camera, a front view camera, a side view camera, and an interior camera.

4. The system of claim 1, wherein the coach management module further comprises a security module to use the first camera in a security surveillance system.

5. The system of claim 1, further comprising a right-side camera for viewing the right side of the motorcoach and a left-side camera for viewing the left side of the motorcoach.

6. The system of claim 5, wherein the coach management module is configured to display, on the monitor, video input from the right-side camera upon triggering a right turn signal, and video input from the left-side camera upon triggering a left turn signal.

7. The system of claim 1, further comprising coach sensors to gather the coach management information, and a coach bus carry the management information to the coach management module.

8. The system of claim 1, wherein the coach management is further configured to simultaneously display vehicle data, with the first video signal, on the rear vision monitor.

9. The system of claim 8, wherein vehicle data is selected from at least one sensor reflecting a status of at least one of the group consisting of an engine, transmission, power train, tire pressure, battery level, odometer, fuel, and braking system.

10. The system of claim 8, wherein:
vehicle data is selected from at least one sensor reflecting a status of a door of the motorcoach; and
the coach management module is configured to at least one of lock and unlock the door as selected by a user.

11. The system of claim 8, wherein the coach management module is configured to log at least one of coach data and vehicle data.

12. The system of claim 8, further comprising vehicle sensors to gather the vehicle data, and a vehicle bus to carry the vehicle data to the coach management module.

13. The system of claim 1, wherein the coach management module further comprises a presentation module to perform a task selected from the group consisting of overlaying text onto the first video signal, providing a split screen to simultaneously display text and video separately, overlaying a second video image onto the first video image, and enabling text and video to be displayed on multiple monitors.

14. The system of claim 1, further comprising a presentation module to overlay text onto the first video signal, the text having a background, and wherein the background is characterized by a property selected from the group consisting of transparent, opaque, textured, and meshed.

15. The system of claim 1, further comprising a user input device for transmitting user-defined parameters to the coach management module.

16. The system of claim 1, wherein the coach management module further comprises a checklist module to display, on the rear vision monitor, a checklist of tasks for managing the motorcoach.

17. The system of claim 1, wherein the coach management module further comprises a trip data module to calculate data and gather information with respect to a trip traveled by the motorcoach.

18. The system of claim 1, further comprising:
a second camera; and
a multiplexer operably connected to the first and second cameras, the multiplexer configured to switch between each of the first and second cameras as selected by a user; and
an output from the multiplexer to carry a video signal from one of the first and second cameras to the coach management module.

19. The system of claim 18, wherein the multiplexer is integrated into the coach management module.

20. The system of claim 18, further comprising a power management module to selectively provide and cut off power to the first and second cameras when designated as active and inactive, respectively.

21. A security system integrated with a rear-vision camera and display monitor, the system comprising:
a rear-vision camera for providing a first video signal comprising captured images of subject matter substantially behind a motorcoach;
a monitor for displaying the first video signal; and
a security module configured to selectively share the monitor, with the rear-vision camera, to display video from at least one security camera.

22. The system of claim 21, wherein the security module further comprises a presentation module to perform a task selected from the group consisting of displaying security camera video, overlaying security system information and video onto the first video signal, providing a split screen to simultaneously display video from a plurality of security cameras, display security system information simultaneously with security camera video, overlay security camera video onto other security camera video, and enabling security system information and video to be displayed on multiple monitors.

23. The system of claim 21, further comprising a multiplexer to switch between at least one of multiple security cameras, and a security camera and the rear-vision camera.

24. The system of claim 23, wherein the multiplexer is integrated into the security module.

25. The system of claim 24, further comprising a power management module to selectively provide and cut off power to the at least one security camera when active and inactive, respectively.

26. The system of claim 21, wherein the rear-vision camera is the at least one security camera.

27. A system for managing subsystems of a vehicle through a rear vision display monitor, the system comprising:
a first camera for providing a first video signal comprising captured images of subject matter within the environment of a vehicle;
a monitor for displaying the first video signal; and
a coach management module configured to display, on the monitor, at least one of tire pressure and tire temperature information corresponding to tires on the vehicle.
